(19) United States
(12) Patent Application Publication
(10) Pub. No.: US 2002/0034623 A1
(43) Pub. Date: Mar. 21, 2002

(54) Non-asbestos friction material

(76) Inventors: Akihiro Hikichi, Tokyo (JP); Mikiya Haruta, Tokyo (JP)

Correspondence Address: Finnegan, Henderson, Farabow,, Garrett & Dunner, L.L.P, 1301 I Street, N.W., Washington, DC, 20005-3315, US

(21) Appl. No.: 09/901,722

(22) Filed: Jul. 11, 2001

(30) Foreign Application Priority Data
Jul. 12, 2000 (JP) P2000-211567

(51) Int. Cl. B32B 27/04; B32B 27/12

(52) U.S. Cl. 428/297.4; 428/292.1; 428/402

(57) ABSTRACT

A non-asbestos friction material includes a fibrous reinforcement, a friction modifier, a binder, and a soluble amorphous substance mixed as friction material components. The soluble amorphous substance is a composition composed of SiO₂ as a principal component, 18 to 40 wt % of at least one kind of CaO and MgO, less than 10 wt % of at least one kind of Al₂O₃ and ZrO₂, and less than 2 wt % of at least one kind of Na₂O, K₂O, FeO and Fe₂O₃. Preferably, the soluble amorphous substance is mixed in a range of from 1 wt % to 30 wt % of a total of the friction material. Preferably, the soluble amorphous substance is fibrous or granular.

### BACKGROUND OF THE INVENTION

1. Field of the Invention

The present invention relates to a friction material, and particularly relates to a friction material for an industrial machine, a railway vehicle, a baggage vehicle, a passenger vehicle, or the like. More particularly, the present invention relates to a brake pad, a brake lining, a clutch facing, etc., for the aforementioned applications.

2. Description of the Related Art

In a friction material principally for a brake or the like, a fibrous reinforcement is used as one of materials for enhancing the strength of the friction material. As such a fibrous reinforcement, ceramic fibers (rock wool, slag wool), glass fibers, steel fibers, aramid fibers, potassium titanate fibers, etc. are available. Since these fibers have their own properties, several kinds of these fibers are mixed in use.

Of these fibers, rock wool is rated highly as an abrasive hard inorganic fibrous reinforcement. That is, rock wool enhances the strength and the heat resistance of the friction material as a whole and improves the wear resistance. At the same time, it heightens the friction coefficient of the friction material due to its abrasive property. Particularly, rock wool can ensure a high friction coefficient at the time of a high load, for example, at the time of high-speed braking.

Rock wool and slag wool are fibrous amorphous substances. Now, according to Q1 of EU Commission 97/69/EC, soluble amorphous fibers harmless to human bodies are defined to be mineral fibers having a length longer than 20 μm and having a weighted half life shorter than 40 days on the basis of a short-term in vivo retentivity test by endotracheal injection.

However, the chemical composition (wt %) of rock wool is typically of 35 to 45 of SiO₂, 10 to 20 of Al₂O₃, 30 to 40 of CaO, 4 to 8 of MgO, 1 to 4 of MnO, and 0.1 to 3 of Fe₂O₃. Thus, in spite of being an amorphous substance, rock wool has the content of Al₂O₃ in a range of from 10 wt % to 20 wt % to be so high that the rock wool is difficult to be soluble in vivo. As a result, it does not come under the above-mentioned definition.

### SUMMARY OF THE INVENTION

It is an object of the present invention to obtain a non-asbestos friction material without using any ceramic fiber such as rock wool, or the like, which is undesirable on the working environmental sanitation. Nevertheless the non-asbestos friction material provides friction properties (effectiveness adjustment, rust removability, and so on) and strength equivalent to those in the case where such ceramic fibers having a high content of the alumina component, and at the same time, it can also restrain the manufacturing cost from increasing.

To solve the foregoing problems, the present inventors carried out various researches on materials or forms of inorganic substances which use no ceramic fiber such as rock wool or the like undesirable on the working environmental sanitation, but which nevertheless provide a friction material with friction properties and strength equivalent to those in the case where such ceramic fibers are used. The problem in the working environmental sanitation is caused by rock wool or slag wool because the composition thereof has a high content of the alumina component in a range of from 10 wt % to 20 wt %.

The present inventors therefore attained the present invention in the following point of view. That is, even if an amorphous inorganic substance containing only a small amount of alumina is used, there still can be friction properties and strength equivalent to those in the case where the above-mentioned amorphous inorganic substance such as rock wool or the like is used. In addition, the solubility of the amorphous inorganic substance in humor is enhanced so that health anxiety can be avoided.

That is, the present invention solved the foregoing problems by the following means.

(1) A non-asbestos friction material including a fibrous reinforcement, a friction modifier, a binder, characterized in that a soluble amorphous substance having a composition composed of SiO₂ as a principal component, 18 to 40 wt % of at least one kind of CaO and MgO, less than 10 wt % of at least one kind of Al₂O₃ and ZrO₂, and less than 2 wt % of at least one kind of Na₂O, K₂O, FeO and Fe₂O₃ are mixed as friction material components.

(2) A non-asbestos friction material according to the paragraph (1), characterized in that the soluble amorphous substance is mixed in a range of from 1 wt % to 30 wt % of a total of the friction material.

(3) A non-asbestos friction material according to the paragraph (1), characterized in that the soluble amorphous substance is fibrous or granular.

(4) A non-asbestos friction material according to the paragraph (1), characterized in that the soluble amorphous substance is formed of fibers having an average fiber diameter in a range of from 2 μm to 9 μm and an average fiber length in a range of from 100 μm to 1,500 pm.

(5) A non-asbestos friction material according to the paragraph (1), characterized in that the soluble amorphous substance is formed of grains having an average grain size in a range of from 2 μm to 100 μm.

### DETAILED DESCRIPTION OF THE PREFERRED EMBODIMENTS

A friction material is constituted by a fibrous reinforcement, a friction modifier, a binder, and so on. According to the present invention, not only asbestos but also in vivo insoluble amorphous substances which are amorphous inorganic substances such as rock wool, slag wool, or the like, undesirable on the working environmental sanitation, and which contains 10 to 20 wt % of alumina, are not used as fibrous reinforcements. In place of such fibrous reinforcements, a fibrous or granular soluble amorphous substance containing not higher than 5 wt % of alumina is used. Incidentally, the word “soluble” means that the substance is soluble in humor when it enters a body.

The soluble amorphous substance according to the present invention is composed of SiO₂, Al₂O₃, ZrO₂, oxides of Na, K, Ca, Mg and Ba, and so on. Preferably, the total amount of the oxides of Na, K, Ca, Mg and Ba exceeds 18wt %.

In the soluble amorphous substance composed of such chemical components, as the component ratio of Al₂O₃ or ZrO₂ is lower, and as the ratio of CaO or MgO is higher, the in-vivo solubility is superior.

That is, in the range of Al₂O₃≦5wt % and ZrO₂≦5wt %, the solubility is more improved as they approach 0 wt %.

On the other hand, as the sum of CaO and MgO becomes large, the solubility is more improved.

However, if the ratio of CaO and MgO is made too high, the heat resistance is lowered. It is therefore desired that the total ratio of CaO and MgO is not higher than 40wt %.

In addition, as trace components, the following oxides, that is, Na₂O, K₂O, FeO and Fe₂O₃ may be contained by less than 2 wt % as the total amount of them.

An example of a preferred soluble amorphous substance is a SiO₂—ZrO₂—CaO—MgO amorphous inorganic substance.

Examples of typical compositions (wt %) include 64.5 of SiO₂, 5.0 of ZrO₂, 17.0 of CaO, and 13.5 of MgO; 65.0 of SiO₂, 29.5 of CaO, and 5.5 of MgO; 65.0 of SiO2, 19.5 of is CaO, and 15.5 of MgO; 65 of SiO₂, 0.3 of Al₂O₃, 31.1 of CaO, 3.2 of MgO, and 0.3 of Fe₂O₃; and so on.

The proportion of the soluble amorphous substance as a friction material component is set to be in a range of from 1 wt % to 30 wt %. If the loading is smaller than 1 wt %, it is difficult to disperse the soluble amorphous substance uniformly when it is mixed and stirred, so that a desired effect cannot be obtained. On the contrary, if the loading is larger than 30 wt %, the effect is improved, but a partner material is worn harder. Thus, the loading is set to be not larger than 30 wt %. Preferably, the loading is set to be in a range of from 2.5 wt % to 30 wt %.

Fibers of the soluble amorphous substance according to the present invention have an average fiber diameter in a range of from 2 μm to 9 μm, preferably in a range of from 3 μm to 6 μm. If the average fiber diameter is not larger than 2 μm, it becomes difficult to manufacture the fibers so that they are not economical. If the average fiber diameter is not smaller than 9 μm, the dispersibility of the fibers when they are mixed with other materials deteriorates. In addition, when the fibers are made into a friction material, the aggressiveness of the friction material against a partner metal to be rubbed deteriorates. In addition, the average fiber length is in a range of from 100 μm to 1,500 μm, preferably in a range of from 500 μm to 1,000 μm. If the average fiber length is shorter than 100 μm, the reinforcement effect cannot be obtained sufficiently. If the average fiber length is longer than 1,500 μm, the dispersibility of the fibers when they are mixed with other materials deteriorates.

Grains of the soluble amorphous substance according to the present invention have an average grain size in a range of from 2 μm to 100 μm, preferably in a range of from 5 μm to 30 μm. If the average grain size is not larger than 2 μm, it becomes difficult to manufacture the grains so that they are not economical. If the average grain size is not smaller than 30 μm, the aggressiveness of a friction material made from the grains against a partner metal to be rubbed deteriorates.

In the friction material according to the present invention, examples of fibrous reinforcements include organic fibers such as aromatic polyamide fibers, fire-resistant acrylic fibers, or the like; metal fibers such as copper fibers, steel fibers, or the like; and inorganic fibers such as potassium titanate fibers, Al₂O₃—SiO₂ ceramic fibers, or the like.

Examples of inorganic fillers include metal particles of copper, aluminum, zinc, or the like; scaly inorganic substances such as vermiculite, mica, or the like; barium sulfate; calcium carbonate; etc.

Examples of thermosetting resin binders include phenolic resin (including straight phenolic resin, and variously modified phenolic resins affected by rubber or the like); melamine resin; epoxy resin; polyimide resin; etc.

In addition, examples of friction modifiers include inorganic friction modifiers such as alumina, silica, magnesia, zirconia, chrome oxide, quartz, or the like; and organic friction modifiers such as synthetic rubber, cashew resin, or the like. Examples of solid lubricants include graphite, molybdenum disulfide, etc.

Various composition ratios can be adopted as the composition of the friction material.

That is, these friction materials may be used individually or in combination of two or more kinds in accordance with friction properties required of a product, for example, a friction coefficient, wear resistance, a vibration property, a friction noise property, and so on.

In a process for manufacturing a brake pad for a disc brake, a pressure plate is formed into a predetermined shape by sheet metal pressing, subjected to degreasing processing and primer processing, and coated with an adhesive agent. A fibrous reinforcement of heat-resistant organic fibers, metal fibers or the like and a powdered raw material of an organic/inorganic filler, a friction modifier, a thermosetting resin binder, and so on are mixed with each other and sufficiently homogenized by stirring. The mixture of the fibrous reinforcement and the powdered raw material are formed (preformed) at room temperature and at predetermined pressure so that a preformed friction material is produced. The pressure plate and the preformed friction material are thermoformed at predetermined temperature and pressure in a thermoforming process so that both the members are fixed integrally with each other. The integrated friction material is after-cured and finally subjected to finishing processing. The manufacturing steps to this point are the same as those in the background-art method.

### EXAMPLES

The present invention will be described specifically on the basis of its examples. However, the present invention is not limited only to these examples.

### Examples 1 to 3 and Comparative Examples 1 and 2

(Materials of Friction Material Samples)

The following materials were used as the materials of friction materials for producing samples of friction materials. When the samples were produced, materials were selected from those materials and their mixture was changed in each sample.

| | |
|---|---|
| Binder | phenolic resin |
| Organic friction modifier | cashew dust |
| Filler | barium sulfate |
| Abrasive | zirconia |
| Solid lubricant | graphite |
| Fibrous reinforcement | copper fibers / |
| | aramid fibers / |
| | ceramic fibers/ |
| | potassium titanate fibers |
| Abrasive | soluble amorphous fibers |
| | or powder |

The chemical composition (wt %) of the soluble amorphous inorganic substance according to the present invention was 64.5% of SiO₂, 5% of ZrO₂, 17% of CaO and 13.5% of MgO (in both the fibrous one and the powder one). In addition, soluble amorphous fibers having a fiber diameter of 4.5 μm and a fiber length of 650 μm were used. Soluble amorphous powder having an average grain size of 10 μm was used.

[Experiments on the Soluble Amorphous Fibers]

(Compositions of the Friction Material Samples)

Compositions of friction materials having mixture ratios shown in the following Table 1 were used for producing samples of the friction materials. Thus, Samples of Examples 1 to 3 were produced.

Incidentally, in order to make comparison, samples containing no soluble amorphous fiber (Comparative Examples 1 and 2) were also produced.

(Producing Samples of Brake Pads)

Brake pads of the friction material samples having the above-mentioned compositions were produced by a background-art producing method.

TABLE 1
(mixture: wt %)

| | Comparative | | | | |
|---|---|---|---|---|---|
| | Examples | | Examples | | |
| Friction Material Component | 1 | 2 | 1 | 2 | 3 |
| Phenolic resin | 10 | 10 | 10 | 10 | 10 |
| Cashew dust | 10 | 10 | 10 | 10 | 10 |
| Barium sulfate | 45 | 50 | 45 | 45 | 45 |
| Zirconia | 2 | 2 | 2 | 2 | 2 |
| Graphite | 8 | 8 | 8 | 8 | 8 |
| Copper fibers/Aramid | 10/5 | 10/5 | 10/5 | 10/5 | 10/5 |
| fibers | | | | | |
| Potassium titanate fibers | 5 | 5 | 5 | 5 | 5 |
| Al₂O₃—SiO₂ ceramic fibers | 5 | — | — | 2.5 | — |
| Soluble amorphous fibers | — | — | 5 | 2.5 | 30 |

(Examination Method)

With a full-size dynamometer as a test machine, the following examinations were performed upon a disc brake using a rotor. Incidentally, as a brake pad, a test piece (T/P) was used.

(1) JASO Effect Evaluation

Friction coefficient and JASO effect evaluation were made on the conditions of an initial speed of 50 km/h, an initial speed of 100 km/h, an initial speed of 130 km/h, and a deceleration α=5.88 m/s².

(2) JASO First-fade Minimum μ

(3) Rust Removing Ratio

A rotor with about 50 μm-thick rust was rubbed with a friction material, and the rust removing ratio was measured after the performance of N(number of braking applications)=200 (times).

If the rust removing ratio is not lower than 80%, the rust removing is accepted.

(4) T/P Braking Rotor Aggressiveness

Rotor wear quantity (μm) per 1,000 brake applications on the conditions of an initial speed of 50 km/h, a deceleration α=0.9 m/s² and a temperature of 100° C.

(Examination Results)

The results of the examinations are shown in Table 2.

TABLE 2

| | Comparative | | | | |
|---|---|---|---|---|---|
| | Examples | | Examples | | |
| | 1 | 2 | 1 | 2 | 3 |
| JASO Effect | | | | | |
| 50 km/h | 0.45 | 0.38 | 0.44 | 0.45 | 0.46 |
| 100 km/h | 0.40 | 0.30 | 0.40 | 0.41 | 0.41 |
| 130 km/h | 0.33 | 0.23 | 0.36 | 0.36 | 0.37 |
| JASO 1st Fade minimum μ | 0.24 | 0.20 | 0.26 | 0.27 | 0.28 |
| Rust removing ratio (%) | 100 | 50 | 100 | 100 | 100 |
| Rotor aggressiveness μm) | 5.5 | 2.0 | 3.2 | 3.7 | 4.6 |

### Examples 4 to 7 and Comparative Examples 3 and 4

[Experiments on the Soluble Amorphous Powder]

(Compositions of the Friction Material Samples)

Compositions of friction materials having mixture ratios shown in the following Table 3 were used for producing samples of friction materials. Thus, Samples of Examples 4 to 7 were produced.

In order to make comparison, samples containing no soluble amorphous powder (Comparative Examples 3 and 4) were also produced.

(Producing Samples of Brake Pads)

Brake pads of the friction material samples having the above-mentioned compositions were produced by a background-art producing method.

TABLE 3
(mixture: wt %)

| | Comparative | | | | | |
|---|---|---|---|---|---|---|
| | Examples | | Examples | | | |
| | 3 | 4 | 4 | 5 | 6 | 7 |
| Phenolic resin | 10 | 10 | 10 | 10 | 10 | 10 |
| Cashew dust | 10 | 10 | 10 | 10 | 10 | 10 |
| Barium sulfate | 45 | 50 | 45 | 45 | 20 | 45 |
| Zirconia | 3 | 3 | 3 | 3 | 3 | 0 |
| Graphite | 7 | 7 | 7 | 7 | 7 | 7 |
| Copper fibers/ | 10/5 | 10/5 | 10/5 | 10/5 | 10/5 | 10/5 |
| Aramid fibers | | | | | | |
| Potassium titanate | 5 | 5 | 5 | 5 | 5 | 5 |
| fibers | | | | | | |
| Al₂O₃—SiO₂ ceramic fibers | 5 | — | — | 2.5 | — | 5 |
| Soluble amorphous powder | — | — | 5 | 2.5 | 30 | 3 |

(Examination Method)

In the same manner as in the examples where the fibers were mixed, the following examinations were performed upon a disc brake using a rotor.

(1) JASO Effect Evaluation

Friction coefficient and JASO effect evaluation were made on the conditions of an initial speed of 50 km/h, an initial speed of 100 km/h, an initial speed of 130 km/h, and a deceleration α=0.6G.

(2) JASO First-fade Minimum μ (the same as that in the case of the fibers)

(3) Rust Removing Ratio (the same as that in the case of the fibers)

(4) T/P Braking Rotor Aggressiveness (the same as that in the case of the fibers)

(Examination Results)

The results of the examinations are shown in Table 4.

TABLE 4

| | Comparative | | | | | |
|---|---|---|---|---|---|---|
| | Examples | | Examples | | | |
| | 3 | 4 | 4 | 5 | 6 | 7 |
| JASO Effect | | | | | | |
| 50 km/h | 0.45 | 0.38 | 0.42 | 0.42 | 0.45 | 0.43 |
| 100 km/h | 0.41 | 0.30 | 0.40 | 0.41 | 0.43 | 0.41 |
| 130 km/h | 0.35 | 0.24 | 0.36 | 0.36 | 0.38 | 0.35 |
| JASO 1st Fade minimum μ | 0.25 | 0.20 | 0.27 | 0.27 | 0.28 | 0.26 |
| rust removing ratio | 100 | 50 | 100 | 100 | 100 | 100 |
| (%) | | | | | | |
| T/P Rotor | 5.9 | 2.1 | 3.6 | 3.9 | 4.8 | 4.3 |
| aggressiveness (μm) | | | | | | |

According to the present invention, by using fibers or powder of a soluble amorphous inorganic substance in which the content of alumina (Al₂O₃) and zirconia (ZrO₂) lowering the solubility in vivo is lower than 10 wt %, preferably not higher than 5 wt %, it is possible to manufacture a friction material having the following effects. That is, the rust removing performance equivalent to that of rock wool or slag wool is ensured. At the same time, the rotor aggressiveness is reduced, and the effect stability is improved. Further, the solubility in vivo is SO high that the environmental safety can be improved. Thus, it is possible to avoid a problem caused by use of ceramic fibers such as rock wool, slag wool, or the like.

What is claimed is:

1. A non-asbestos friction material comprising:
a fibrous reinforcement;
a friction modifier;
a binder; and
a soluble amorphous substance mixed as friction material components,
wherein the soluble amorphous substance is a composition composed of SiO₂ as a principal component, 18 to 40 wt % of at least one kind of CaO and MgO, less than 10 wt % of at least one kind of Al₂O₃ and ZrO₂, and less than 2 wt % of at least one kind of Na₂O, K₂O, FeO and Fe₂O₃.

2. The non-asbestos friction material according to claim 1, wherein the soluble amorphous substance is mixed in a range of from 1 wt % to 30 wt % of a total of said friction material.

3. The non-asbestos friction material according to claim 1, wherein the soluble amorphous substance is fibrous or granular.

4. The non-asbestos friction material according to claim 1, wherein the soluble amorphous substance is formed of fibers having an average fiber diameter in a range of from 2 μm to 9 μm and an average fiber length in a range of from 100 μm to 1,500 μm.

5. The non-asbestos friction material according to claim 1, wherein the soluble amorphous substance is formed of grains having an average grain size in a range of from 2 μm to 100 μm.
